(19) United States
(12) Patent Application Publication
(10) Pub. No.: US 2025/0030180 A1
(43) Pub. Date: Jan. 23, 2025

(54) Waterproof Device for Connecting Branch Wire with Main Wire

(71) Applicant: Yuyao Joywee Electrics Co.,Ltd., Yuyao (CN)

(72) Inventor: Haiqiang Wu, Yuyao (CN)

(73) Assignee: Yuyao Joywee Electrics Co.,Ltd, Yuyao (CN)

(21) Appl. No.: 18/223,567

(22) Filed: Jul. 19, 2023

(51) Int. Cl. H01R 4/2406; H01R 4/50; H01R 13/52

(52) U.S. Cl. CPC H01R 4/2406; H01R 4/5033; H01R 13/52

(57) ABSTRACT

The present invention discloses a waterproof device for connecting branch wire with main wire, which comprises a housing component with a double-station structure and two puncture locking screw components matched with the housing component, wherein the housing component consists of a housing and a first insulation sealant in a branch wire hole thereof, and the puncture locking screw component consists of a hexagon screw, a metal spike, a second insulation sealant and a cover plate. The device provided by the present invention is compact in structure, does not need to peel the jackets of the main wire and the branch wire during connection, and the connection is quick with good performance of waterproof and insulation.

### TECHNICAL FIELD

The present invention relates to the technical field of electrical connectors, in particular to a waterproof device for connecting branch wire with main wire.

### BACKGROUND

In the operation of connecting wires, when the branch wire needs to be connected with the main wire, if use electrical tape to do the job, it needs to peel off part of jacket of the main wire and the end of branch wire, so that the metal conductors expose. The metal conductor of the branch wire needs to be wound around the metal conductor of the main wire, and then using electrical tape to twine around to protect the splice. This method is inefficient and the splice is hard to be waterproof.

In order to solve the above technical problems, many wiring devices had been created in the past. For example, U.S. Pat. No. 9,147,146 B1 discloses an electrical cable connector with special structure. When the body members are moved to the closed position of the body, the ends of conductors simultaneously cut through insulation and come into electrical connection with two cores of a first cable. A connecting element electrically connects the conductors to respective cores of second electrical cable. Although the electrical cable connector is easy to use, but it can't be waterproof and can't be used for the connection of wires of electric supply. There are also other similar solutions, but most of them are not waterproof or waterproof but clumsy.

Based on the above problems, for the connection of strand wires, it is necessary to create a new waterproof device for connecting branch wire and main wire, which does not need to peel off the jackets of the main wire and the branch wire, saves time of operation, and is waterproof. The new waterproof device can be widely used for low volt lights and other applications which need to connect strand wires for low volt or electric supply.

### SUMMARY

The present invention provides a waterproof device for connecting branch wire with main wire, which includes a housing component with inner screw and puncture locking screw component matching with the inner screw on the housing component, wherein the housing component comprises a housing, one side of the housing is provided with an opening slot for placing the main wire and two positioning steps for the main wire; a branch wire hole is also formed on the housing for inserting and installing the branch wire; the puncture locking screw component comprises a metal spike, and when the puncture locking screw component is screwed into the housing component, the metal spike pierces through the main wire and the branch wire to connect their conductors; sealing material is prefilled in the branch wire hole and the cavity on top of the puncture locking screw, to push the cover plate on top of the cavity can move the sealing material from the cavity to seal the main wire. The waterproof device for connecting branch wire with main wire can have structure of single station or double stations.

### BRIEF DESCRIPTION OF DRAWINGS

In order to explain the technical solution of this application more clearly, the drawings needed in the implementation will be briefly introduced below. The drawings introduce a double stations waterproof device for connecting branch wire with main wire. Obviously, the drawings described below are only some implementations of this application. For those skilled in the art, other drawings can be obtained according to these drawings without creative work.

FIG. 1 is a schematic diagram of a waterproof device for connecting branch wire with main wire provided by the present invention;

FIG. 2 is a schematic diagram of the main wire in FIG. 1 when the second insulation sealant is pushed onto the main wire;

FIG. 3 is a sectional view of a waterproof device for connecting branch wire with main wire provided by the present invention with finished connection;

FIG. 4 is a schematic diagram of a waterproof device for connecting branch wire with main wire provided by the present invention with finished connection;

FIG. 5-1 is a sectional view of a waterproof device for connecting branch wire with main wire provided by the present invention;

FIG. 5-2 is a schematic diagram without filling the first insulation sealant and the second insulation sealant in FIG. 5-1;

FIG. 6 is a cross-section view of the housing;

FIG. 7 is a schematic diagram of the bottom structure of the hexagon screw;

FIG. 8 is an outdoor installation diagram of a waterproof device for connecting branch wire with main wire provided by the present invention.

In the figures: 10, Waterproof device for connecting branch wire and main wire (hereinafter called ‘waterproof device’); 11, Housing component; 111, Housing; 111A, A pair inner threads; 111B, Positioning step for main wire; 111C, Blocking water step; 111D, Through hole for puncturing main wire and branch wire (hereinafter called ‘through hole’); 111E, Positioning step for branch wire; 111F, Branch wire hole; 112, First insulation sealant; 12, Puncture locking screw component; 121, Hexagon screw; 121A, Top cavity; 121B, Small hole; 121C, Bottom cavity; 122, Metal spike; 123, Second insulation sealant; 124, Cover plate; 20, Main wire; 30, Branch wire.

### DESCRIPTION OF EXAMPLES

In the following, the technical solution in the example of the application will be clearly and completely described with reference to the drawings in the example of the application. Obviously, the described example is only a part of the examples of the application, but not the whole examples. Based on the example in this application, other examples obtained by those skilled in the art without creative labor belong to the protection scope of this application.

Reference to “an example” or “an example” herein methods that a particular feature, structure or characteristic described in connection with an example or an example can be included in at least one example of this application. The appearance of this phrase in various places in the specification does not necessarily refer to the same example, nor is it an independent or alternative example mutually exclusive with other examples. It is understood explicitly and implicitly by those skilled in the art that the example described herein can be combined with other examples.

In this specification, for the sake of convenience, words and expressions indicating orientation or positional relationship such as “middle”, “top”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, it is not limited to the words and expressions described in the specification, and can be replaced appropriately according to the situation.

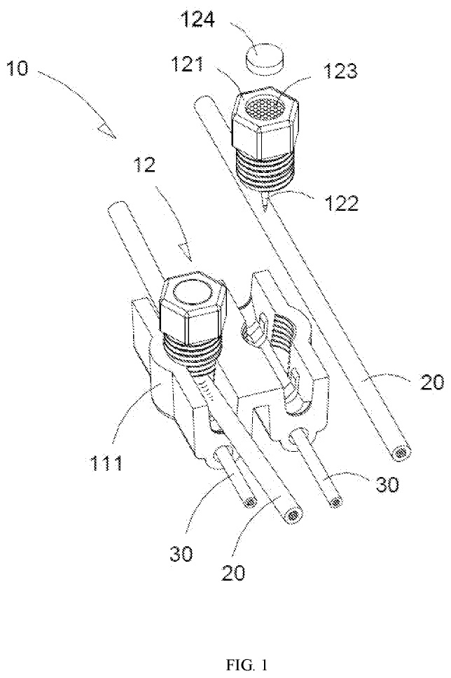

As shown in FIG. 1 to FIG. 8, a waterproof device for connecting branch wire with main wire provided by the present invention includes a housing component 11 and a puncture locking screw component 12 matched with the housing component 11, wherein the housing component 11 includes a housing 111, a pair inner threads 111A is located at the middle of opening slot, one side of the housing 111 is provided with an opening slot for placing the main wire 20 and a positioning step for main wire 111B for positioning the main wire 20; a branch wire hole 111F is also formed on the housing 111 for inserting and installing the branch wire 30; the puncture locking screw component 12 includes a metal spike 122, and when the puncture locking screw component 12 is screwed into a pair inner threads 111A, the metal spike 122 pierces into the cores of the main wire 20 and the branch wire 30 to realize the conduction of electricity.

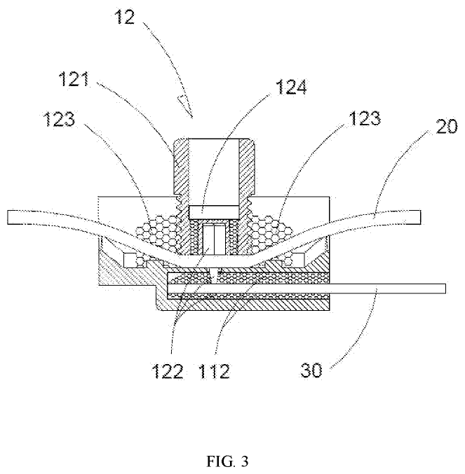

As a preferred example of the present invention, as shown in FIG. 3, the housing component 11 further includes a first insulation sealant 112, which is prefilled in the branch wire hole 111F to seal the branch wire 30 inserted into the hole. The insulation sealant can be silicone grease, which is waterproof and corrosion-proof. In this example, silicone grease sealant is preferably used, and in other examples, sealants made of other polymer materials can also be used.

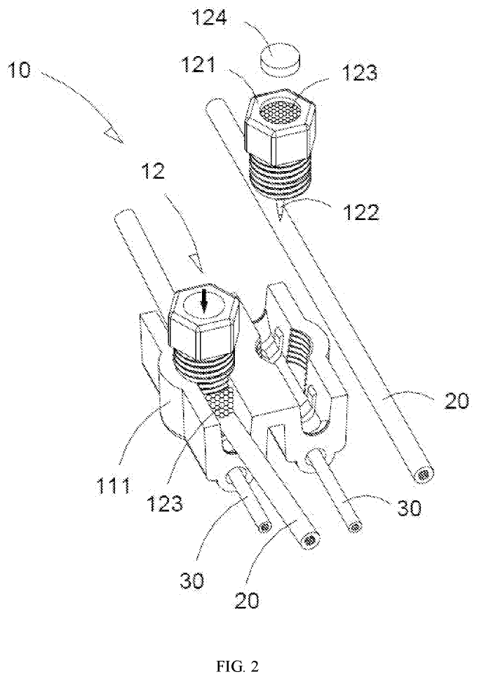

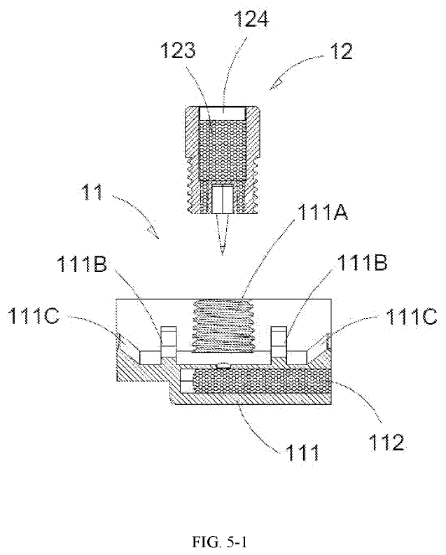

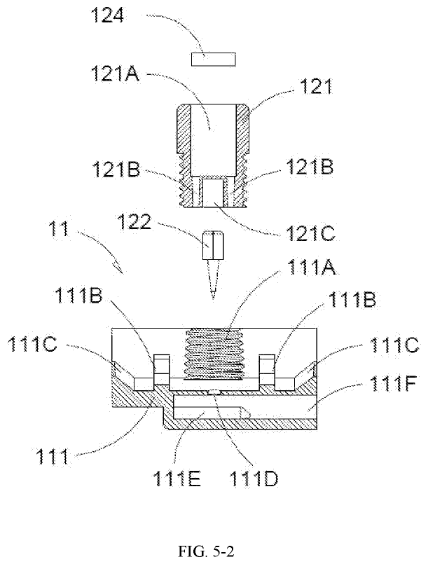

Specifically, as shown in FIG. 5-2, one surface of the housing 111 is provided with an opening slot, the middle section of the opening slot is provided with a pair of inner threads 111A; the bottom of the middle section of the opening slot is provided with a through hole 111D, which is used to connect the branch wire hole 111F extending from the side; the bottom of the rear section of the branch wire hole 111F is provided with a V-type positioning step for branch wire 111E, and the bottom of the opening slot is provided with two V-type main wire positioning steps 111B, which are located on two sides of the puncture position respectively; and blocking water step 111C are also arranged at the two ends of the opening slot.

As shown in FIG. 5-1, the puncture locking screw component 12 is composed of a hexagon screw; 121, a metal spike 122, a second insulation sealant 123 and a cover plate 124. The head of the hexagon screw 121 is provided with a top cavity 121A, and the bottom of the cavity is provided with a plurality of small holes 121B. The center of the bottom of the hexagon screw 121 is provided with a hexagonal bottom cavity 121C for installing the metal spike 122. The top cavity 121A is prefilled with a sufficient amount of the second insulation sealant 123 and covered with the cover plate 124.

In this example, the puncture locking screw component 12 is preferably configured as a hexagon screw 121. In other examples, the puncture locking screw component 12 can also be composed of a T-shaped screw or a butterfly screw; which can be configured by users according to actual use requirements.

More specifically, as shown in FIG. 1, the top cavity 121A of the hexagon screw 121 is filled with the second insulation sealant 123. When the puncture locking screw component 12 is screwed into a pair inner threads 111A of opening slot, the main wire 20 can be pushed to the bottom of the opening slot firstly. The locking operation should be stopped when it's screwed into 2˜3 teeth, as the left station shown in FIG. 2, a screwdriver or other suitable rods can be used to quickly push the cover plate 124 to press the second insulation sealant 123 to flow evenly around the main wire 20 through the six small holes 121B. Then the puncture locking screw component 12 need to be continually screwed in until it locks the main wire 20 tightly.

As shown in FIG. 3, the cover plate 124 is pushed to the bottom of the top cavity 121A. During this process, the second insulation sealant 123 flows around the main wire 20 through the six small holes 121B evenly, and the redundant second insulation sealant 123 overflows to the openings on both sides of the hexagon screw 121.

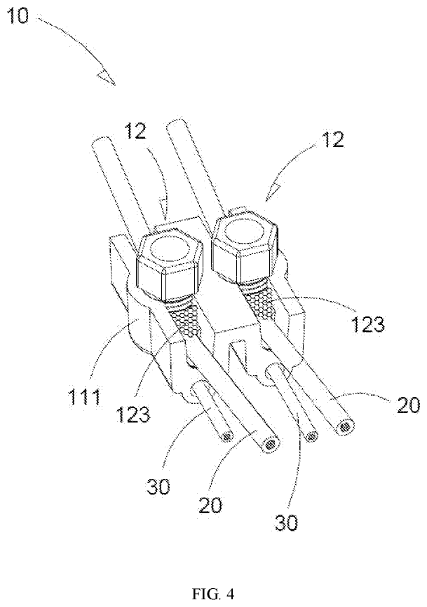

When the connections of double stations are completed, as shown in FIG. 4, the metal spike 122 of the puncture locking screw component 12 penetrates the main wire 20 and the branch wire 30 to make their conductors connected. Around the pierced hole, the main wire 20 is pressed by the bottom of the hexagon screw 121 and sealed by the second insulation sealant 123 in all directions, thus it has good sealing performance.

As shown in FIG. 5-1 and FIG. 5-2, when the second insulation sealant 123 is prefilled in top cavity 121A, all the small holes 121B can be filled with the extra second insulation sealant 123 when the cover plate 124 is assembled, so the prefilled volume of the second insulation sealant 123 should be controlled to ensure no overflowing from any small hole 121B.

As a preferred example of the present invention, the positioning step for main wire 111B can reduce the swinging of the main wire 20 during the process of puncturing, and the blocking water step 111C can reduce rainwater flowing to the center of the waterproof device 10 when it is installed with the opening slots facing ground. The through hole 111D is arranged for the metal spike 122 to go through and can be used as a nozzle to fill in the first insulation sealant 112. Considering that the first insulation sealant 112 may overflow into the opening slot of the housing 111 during the insertion of a thicker branch wire 30, the through hole 111D is preferably configured as a thin-bottomed stepped hole, and the bottom thickness of the stepped hole can be controlled to be 0.2-0.3 mm, and the diameter is about 1 mm. In other examples, the bottom thickness and diameter of the stepped hole may have other values.

In this example, the positioning step of branch wire 111E is preferentially arranged in the rear half of the branch wire hole 111F, so that the branch wire 30 can be always centrally positioned. As the branch wire hole 111F is too deep, a small amount of air may be sealed at the bottom of the branch wire hole 111F when the first insulation sealant 112 is filled in, but it doesn't affect the performance of waterproof and insulation.

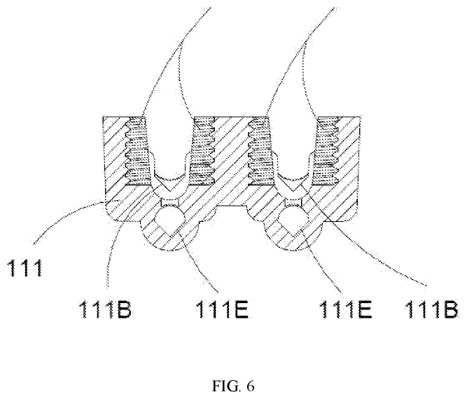

As shown in FIG. 6, a pair inner threads 111A is composed of a left part of inner threads and a right part of inner threads with each part counts about ⅓ of the full inner threads, and the positioning step of main wire 111B and the positioning step of branch wire 111E are configured for centering the main wire 20 and the branch wire 30 respectively.

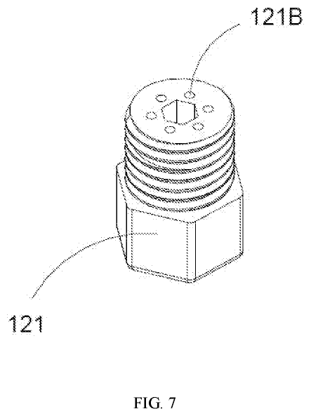

As shown in FIG. 7, the six small holes 121B are evenly located at the outer side of the six sides of the bottom cavity 121C, so that the second insulation sealant 123 can flow around the main wire 20 much evenly when the cover plate 124 is pushed.

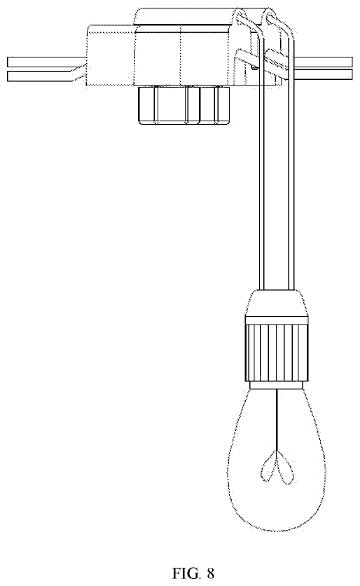

FIG. 8 is an outdoor installation diagram of the waterproof device 10 provided by the present invention. During the installation, the side of the opening slot of the housing 111 is installed downward, which can significantly improve the sealing performance and service life of the waterproof device 10 for outdoor application. It should be pointed out that, in order to facilitate the display, FIGS. 1 to 6 adopt a drawing mode in which the side of the opening slot of housing 111 is arranged upward.

In specific use, in order to facilitate the understanding of the present invention, it is described with the attached drawings;

The waterproof device 10 is used for the connection of strand wires, and its operation methods are as follows:
1, screw off the two puncture locking screw components 12 from the housing component 11;
2, use one puncture locking screw component 12 to puncture a small hole on each main wire 20 for easy positioning with the main wire 20 upon the platform of the housing 111;
3, put one main wire 20 into one opening slot of the housing 111;
4, use one puncture locking screw component 12 to position the small hole formed on the main wire 20, and then screw into 2˜3 teeth;
5, push the cover plate 124 to press the second insulation sealant 123 onto the main wire 20 by a suitable rod;
6, insert the related branch wire 30 into the branch wire hole 111F to the end;
7, continue to screw the puncture locking screw component 12 to lock the main wire 20 tightly to finish the connection of the main wire 20 and the branch wire 30;
8, repeat the above operations from 3 to 7 to finish the connection of another main wire 20 and branch wire 30.

The waterproof device provided by the present invention has a compact structure, doesn't need to peel the jackets of main wire and branch wire, the operation is quite quick with good waterproof and insulation performance of the splice connected, and it can only be used for the connection of strand wires.

The technical methods disclosed in the solution of the present invention are not limited to the technical methods disclosed in the above example, but also include the technical solution composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. A waterproof device for connecting branch wire with main wire, comprising a housing component and a puncture locking screw component matched with the housing component, wherein the housing component comprises a housing, one side of the housing is provided with an opening slot for placing the main wire and two positioning steps for the main wire; a branch wire hole is also formed on the housing for inserting and installing the branch wire; the puncture locking screw component comprises a metal spike, and when the puncture locking screw component is screwed into the housing component, the metal spike pierces through the main wire and the branch wire to connect their conductors.

2. The waterproof device for connecting branch wire with main wire as claimed in claim 1, wherein the housing component is made of plastic with a double-station structure, and there are two corresponding puncture locking screw components.

3. The waterproof device for connecting branch wire with main wire as claimed in claim 2, wherein the housing is provided with two opening slots with a pair of inner threads at the middle; the puncture locking screw component comprises a hexagon screw made of plastic and a metal spike made of brass, the metal spike is fixed in the hole on the bottom of the hexagon screw, and the hexagon screws fit the inner threads.

4. The waterproof device for connecting branch wire with main wire as claimed in claim 3, wherein two water blocking steps are also formed on two sides of the opening slot of the housing to reduce the affecting of rain.

5. The waterproof device for connecting branch wire with main wire as claimed in claim 1, wherein a V-type branch wire positioning step is arranged on a bottom surface of a rear section of the branch wire hole to center the branch wire in the operation of connecting.

6. The waterproof device for connecting branch wire with main wire as claimed in claim 5, wherein the branch wire hole is prefilled with a first insulation sealant, and a through hole locates between the opening slot and the branch wire hole for the metal spike to go through.

7. The waterproof device for connecting branch wire with main wire as claimed in claim 6, wherein the through hole for puncturing main wire and branch wire has a thin wall at the bottom, the thickness is 0.2-0.3 mm, the diameter of bottom hole is about 1 mm, and the diameter of the top hole can be flared to facilitate the metal spike to go through.

8. The waterproof device for connecting branch wire with main wire as claimed in claim 3, wherein the head of the hexagon screw is provided with a top cavity, the bottom of the top cavity is provided with a plurality of small holes, and the bottom of the hexagon screw is provided with a regular hexagonal bottom cavity for installing the metal spike; the puncture locking screw component further comprises a second insulation sealant pre-filled in the top cavity and a cover plate to cover the second insulation sealant.
